(19) United States
(12) Patent Application Publication
(10) Pub. No.: US 2026/0336427 A1
(43) Pub. Date: Oct. 29, 2026

(54) DRIVING ROBOT USING PLURALITY OF DRIVING MODULES AND DRIVING METHOD THEREOF

(71) Applicant: SAMSUNG ELECTRONICS CO., LTD., Suwon-si (KR)

(72) Inventors: Minhee LEE, Suwon-si (KR); Sanghyun KANG, Suwon-si (KR); Hyunsuk KWAK, Suwon-si (KR); Donghan KOO, Suwon-si (KR); Jaemyung CHO, Suwon-si (KR)

(73) Assignee: SAMSUNG ELECTRONICS CO., LTD., Suwon-si (KR)

(21) Appl. No.: 19/699,603

(22) Filed: Jun. 5, 2026

Related U.S. Application Data
(63) Continuation of application No. PCT/KR2024/016799, filed on Oct. 30, 2024.

(30) Foreign Application Priority Data
Dec. 7, 2023 (KR) 10-2023-0176989

(51) Int. Cl. B60L 15/20; B60L 15/42

(52) U.S. Cl. CPC B60L 15/20; B60L 15/42; B60L 2240/64; B60L 2260/28; B60L 2260/42

(57) ABSTRACT

A driving robot includes: a main body; a plurality of driving modules rotatably connected on a lower side of the main body, each driving module of the plurality of driving modules including a sensor, a plurality of wheels, and a motor configured to drive the plurality of wheels; and at least one processor configured to: rotate plurality of driving modules based on rotation directions of the plurality of driving modules that are determined based on a direction in which the robot is to drive, identify at least one driving module, among the plurality of driving modules, that is not in contact with a bottom surface based on a sensing value of the sensor of the at least one driving module, and control the motor of the at least one driving module to drive the plurality of wheels of the at least one driving module at different rotation speeds.

### CROSS-REFERENCE TO RELATED APPLICATIONS

This application is a continuation of International Application No. PCT/KR2024/016799, filed on Oct. 30, 2024, which is based on and claims priority to Korean Patent Application No. 10-2023-0176989, filed on Dec. 7, 2023, in the Korean Ministry of Intellectual Property, the disclosures of which are incorporated by reference herein in their entireties.

### BACKGROUND

### 1. Field

The disclosure relates to a driving robot using a plurality of driving modules and a driving method thereof.

### 2. Description of Related Art

With advancements of robot technologies, various types of driving robots such as a robot cleaner, a movable projector, a serving robot, etc. are being developed and distributed. A driving robot can drive by using a driving module. Specifically, a plurality of wheels are included in a driving module, and the driving robot may perform various operations such as going forward/going backward/stop/rotation, etc. by controlling the plurality of wheels included in the driving module to rotate at the same speed or different speeds.

As described above, as a driving module determines a driving direction and the speed of a driving robot by controlling the rotation speed of a plurality of wheels, if the plurality of wheels included in the driving module get in a state of not contacting the bottom surface, the rotation speed of the wheels cannot be controlled. Accordingly, a problem that the driving robot cannot drive in a direction and at a speed that it intends to drive may occur.

### SUMMARY

According to an aspect of the disclosure, there is provided a driving robot including: a main body; a plurality of driving modules that are rotatably connected on a lower side of the main body, each driving module of the plurality of driving modules including a sensor, a plurality of wheels, and a motor configured to drive the plurality of wheels; and at least one processor configured to: rotate each of the plurality of driving modules based on rotation directions of the plurality of driving modules that are determined based on a direction in which the robot is to drive, identify at least one driving module, among the plurality of driving modules, that is not in contact with a bottom surface based on a sensing value of the sensor of the at least one driving module, and control the motor of the at least one driving module to drive the plurality of wheels of the at least one driving module at different rotation speeds.

The at least one processor may be further configured to, based on the at least one driving module rotating in a rotation direction that is determined based on the direction in which the robot is to drive, control the motor of the at least one driving module to rotate the plurality of wheels of the at least one driving module at a same rotation speed.

The at least one processor may be further configured to: based on identifying that the at least one driving module is not in contact with the bottom surface, control the motor of the at least one driving module to rotate a wheel, among the plurality of wheels of the at least one driving module, disposed on an opposite side of the rotation direction that is determined for the at least one driving module at a speed that is faster than rotation speeds of the plurality of wheels of each of remaining driving modules of the plurality of driving modules, and rotate a wheel arranged in the rotation direction, among the plurality of wheels of the at least one driving module, at a speed slower than rotation speeds of the wheels of the plurality of wheels of each of remaining driving modules of the plurality of driving modules.

The driving robot may further include memory, and the at least one processor may be further configured to: obtain first odometry information of the robot based on sensing values of the sensor of each of the plurality of driving modules while the robot is driving according to driving of the plurality of driving modules and store the information in the memory, based on the at least one driving module, among the plurality of driving modules, not contacting the bottom surface, obtain second odometry information of the robot based on sensing values of the sensor of each of remaining driving modules of the plurality of driving modules excluding the at least one driving module and store the information in the memory, and identify a location of the robot based on the first odometry information and the second odometry information.

The at least one processor may be further configured to, based on identifying that a load current of the motor of at least one driving module among the plurality of driving modules became smaller than load currents of the motors of remaining driving modules, among the plurality of driving modules, by greater than or equal to a predetermined amount, identify the at least one driving module including the motor having the identified load current as the driving module that is not in contact with the bottom surface.

The sensor may include an absolute encoder configured to sense a rotation direction of the driving module, and the at least one processor may be further configured to, based on identifying a driving module, among the plurality of driving modules, that did not rotate in a rotation direction determined based on the direction in which the robot is to drive, identify the driving module as the driving module that is not in contact with the bottom surface based on an output value of the absolute encoder.

The at least one processor may be further configured to: based on identifying that a driving route of the robot is a straight route, control the motor of the at least one driving module to rotate the plurality of wheels of the at least one driving module at different rotation speeds until the at least one driving module is aligned with remaining driving modules of the plurality of driving modules, and based on identifying that the at least one driving module was aligned with the remaining driving modules based on a sensing value of the sensor, control the motor provided in the at least one driving module to rotate the plurality of wheels of the at least one driving module at a same speed as the plurality of wheels of each of the remaining driving modules.

The at least one processor may be further configured to: based on identifying that a driving route of the robot is a curved route, control the motor of the at least one driving module to rotate the plurality of wheels of the at least one driving module at different rotation speeds until the at least one driving module rotates in the determined rotation direction, and based on identifying that the at least one driving module was aligned in the determined rotation direction based on a sensing value of the sensor of the at least one driving module, control the motor of the at least one driving module to adjust the rotation speeds of the plurality of wheels of the at least one driving module to a same target speed, and the determined rotation direction may be determined based on a relation between a location of a center of rotation of the curved route and a location of the at least one driving module.

According to an aspect of the disclosure, there is provided a driving method of a driving robot including a plurality of driving modules, the driving method including: rotating each of the plurality of driving modules such that the plurality of driving modules rotate in rotation directions of each of the plurality of driving modules that are determined based on a direction in which the driving robot is to drive; identifying at least one driving module, among the plurality of driving modules, that is not in contact with a bottom surface; and rotating a plurality of wheels included in the at least one driving module at different rotation speeds.

The driving method may further include, based on the at least one driving module rotating in a rotation direction that is determined based on the direction in which the robot is to drive, rotating the plurality of wheels of the at least one driving module at a same rotation speed.

The rotating the plurality of wheels of the at least one driving module at different rotation speeds may include: rotating a wheel, among the plurality of wheels of the at least one driving module, disposed on an opposite side of the rotation direction that is determined for the at least one driving module at a speed faster than the rotation speeds of the wheels provided in remaining driving modules of the plurality of driving modules; and rotating a wheel arranged in the rotation direction among the plurality of wheels of the at least one driving module at a speed slower than rotation speeds of wheels of the remaining driving modules of the plurality of driving modules.

The driving method may further include obtaining first odometry information of the robot while the robot is driving according to driving of the plurality of driving modules; based on the at least one driving module among the plurality of driving modules not contacting the bottom surface, obtaining second odometry information of the robot based on information obtained from the remaining driving modules excluding the at least one driving module; and identifying a location of the robot based on the first odometry information and the second odometry information.

The identifying the at least one driving module that is not in contact with the bottom surface may include, based on identifying that a load current of a motor included in at least one driving module among the plurality of driving modules became smaller than load currents of motors included in remaining driving modules among the plurality of driving modules by greater than or equal to a predetermined amount, identifying the at least one driving module including the motor having the identified load current as the at least one driving module that is not in contact with the bottom surface.

The identifying the at least one driving module that is not in contact with the bottom surface may include, based on identifying a driving module, among the plurality of driving modules, that did not rotate in a rotation direction determined based on the direction in which the robot is to drive, identifying the identified driving module as the driving module that is not in contact with the bottom surface based on an output value of an absolute encoder included in each of the plurality of driving modules.

The driving method may further include based on identifying that a driving route of the robot is a straight route, controlling the motor of the at least one driving module to rotate the plurality of wheels of the at least one driving module at different rotation speeds until the at least one driving module is aligned with remaining driving modules of the plurality of driving modules and based on identifying that the at least one driving module was aligned with the remaining driving modules based on a sensing value of the sensor, controlling the motor provided in the at least one driving module to rotate the plurality of wheels of the at least one driving module at a same speed as the plurality of wheels of each of the remaining driving modules.

The driving method may further include based on identifying that a driving route of the robot is a curved route, controlling the motor of the at least one driving module to rotate the plurality of wheels of the at least one driving module at different rotation speeds until the at least one driving module rotates in the determined rotation direction and based on identifying that the at least one driving module was aligned in the determined rotation direction based on a sensing value of the sensor of the at least one driving module, controlling the motor of the at least one driving module to adjust the rotation speeds of the plurality of wheels of the at least one driving module to a same target speed, wherein the determined rotation direction is determined based on a relation between a location of a center of rotation of the curved route and a location of the at least one driving module.

According to an aspect of the disclosure, there is provided a non-transitory computer-readable recording medium storing computer instructions which, when executed by a processor of a driving robot including a plurality of driving modules, cause the driving robot to perform operations including: rotating each of the plurality of driving modules such that the plurality of driving modules rotate in rotation directions of each of the plurality of driving modules that are determined based on a direction in which the driving robot is to drive; identifying at least one driving module, among the plurality of driving modules, that is not in contact with a bottom surface; and rotating a plurality of wheels included in the at least one driving module at different rotation speeds. The non-transitory computer-readable recording medium may further include based on the at least one driving module rotating in a rotation direction that is determined based on the direction in which the robot is to drive, rotating the plurality of wheels of the at least one driving module at a same rotation speed.

The non-transitory computer-readable recording medium may further include based on identifying that the at least one driving module is not in contact with the bottom surface, rotating a wheel, among the plurality of wheels of the at least one driving module, disposed on an opposite side of the rotation direction that is determined for the at least one driving module at a speed that is faster than rotation speeds of the plurality of wheels of each of remaining driving modules of the plurality of driving modules, and rotating a wheel arranged in the rotation direction, among the plurality of wheels of the at least one driving module, at a speed slower than rotation speeds of the wheels of the plurality of wheels of each of remaining driving modules of the plurality of driving modules.

The non-transitory computer-readable recording medium may further include obtaining first odometry information of the robot based on sensing values of the sensor of each of the plurality of driving modules while the robot is driving according to driving of the plurality of driving modules and storing the information in the memory, based on the at least one driving module, among the plurality of driving modules, not contacting the bottom surface, obtaining second odometry information of the robot based on sensing values of the sensor of each of remaining driving modules of the plurality of driving modules excluding the at least one driving module and storing the information in the memory, and identifying a location of the robot based on the first odometry information and the second odometry information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for illustrating a driving robot according to an embodiment of the disclosure;

FIG. 2 is a block diagram for illustrating a configuration of a driving robot according to an embodiment of the disclosure;

FIG. 3 is a block diagram for illustrating a configuration of a driving module according to an embodiment of the disclosure;

FIG. 4 is a diagram for illustrating a configuration of a driving module according to an embodiment of the disclosure;

FIG. 5 is a diagram for illustrating a method of identifying a driving module that is not in contact with a bottom surface of a driving robot according to an embodiment of the disclosure;

FIG. 6 is a diagram for illustrating a method of controlling a plurality of wheels of a driving robot according to an embodiment of the disclosure;

FIG. 7 is a diagram for illustrating a method of identifying a driving module that is not in contact with a bottom surface of a driving robot according to an embodiment of the disclosure;

FIG. 8 is a diagram for illustrating a method of driving on a curved route of a driving robot according to an embodiment of the disclosure;

FIG. 9 is a flow chart for illustrating a driving method of a driving robot according to an embodiment of the disclosure; and

FIG. 10 is a flow chart for illustrating a method of identifying a location of a driving robot according to an embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Further, in case it is determined that in describing the disclosure, detailed explanation of related known functions or components may unnecessarily confuse the gist of the disclosure, the detailed explanation will be omitted.

In addition, the embodiments below may be modified in various different forms, and the scope of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including only A, (2) including only B, or (3) including both A and B.

Also, the expressions “first,” “second,” and the like used in the disclosure may describe various elements regardless of any order and/or degree of importance. Also, such expressions are used only to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. The term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Also, in the embodiments of the disclosure, ‘a module’ or ‘a unit’ may perform at least one function or operation, and may be implemented as hardware or software, or as a combination of hardware and software. Further, a plurality of ‘modules’ or ‘units’ may be integrated into at least one module and implemented as at least one processor, excluding ‘a module’ or ‘a unit’ that needs to be implemented as specific hardware.

Various elements and areas in the drawings were illustrated schematically. Accordingly, embodiments of the disclosure are not limited by the relative sizes or intervals illustrated in the accompanying drawings.

Hereinafter, embodiments according to the disclosure will be described in detail with reference to the accompanying drawings, such that those having ordinary skill in the art to which the disclosure belongs can easily carry out the disclosure.

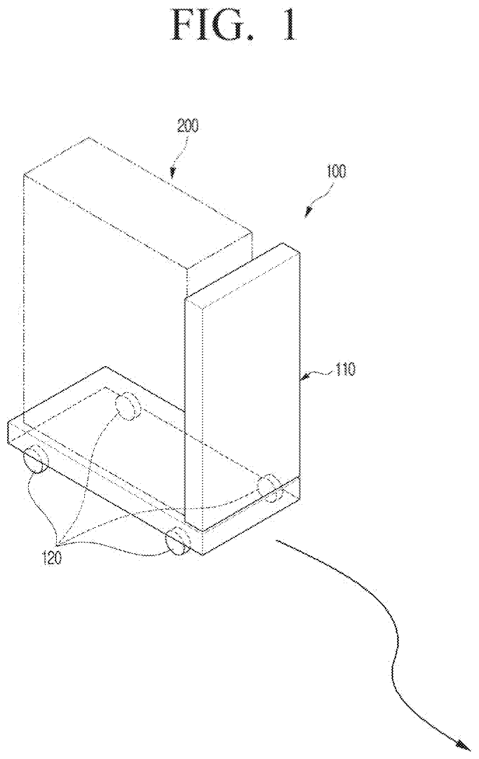

FIG. 1 is a diagram for illustrating a driving robot according to an embodiment of the disclosure.

A driving robot may be a device that can drive while a person does not control it directly. According to FIG. 1, a driving robot 100 may move while loading an object 200 that needs to be carried in a manufacturing factory. The driving robot 100 may alternatively be referred to as an autonomous mobile robot (AMR), an automated guide vehicle (AGB), an unmanned ground vehicle (UGB), etc., but it will be described as the driving robot 100 in the disclosure. The driving robot 100 may be implemented as various types of robots, etc. that perform necessary tasks while driving in a space such as a cleaning robot, a serving robot, a movable projector, a guide robot, a delivery robot, etc.

According to the disclosure, the driving robot 100 may include a plurality of driving modules on the lower side. A driving module may be a component that can move the main body while supporting the main body on the bottom surface. The driving module may alternatively be referred to as various terms such as a wheel module, a moving module, a driving unit, a driving part, etc., but it will be described as the driving module in the disclosure.

In the driving module, at least one moving means may be included. The moving means may be implemented as a wheel, a continuous track or a crawler track, etc. In the embodiments of the disclosure, explanation will be described based on a case wherein one driving module is implemented in a form of including a plurality of wheels, in particular, two wheels, but the number or types of wheels are not limited thereto, and they may be modified variously.

The plurality of driving modules may be coupled with the main body of the driving robot 100 in a rotatable form and support the main body. For example, between each driving module and the main body of the driving robot 100, a rotatable hinge may be arranged. Specifically, on the upper side of each driving module, a protruding element that protrudes to be able to be coupled with the main body 110 and is in a form of a big cylinder wherein the diameter of the upper side is bigger than the diameter of the lower side may be provided, and on the lower side of the main body 110, a space wherein the upper side of the protruding element can be accommodated and a hole that is smaller than the upper diameter of the protruding element, and is bigger than the lower diameter of the protruding element may be formed. A part wherein the hole and the protruding element are connected may perform a role of a hinge. In other words, the protruding element may be mounted inside the space through the hole, and may rotate inside the space. Between the hole and the protruding element, a lubricating element for decreasing a frictional force, or a bearing, etc. may be additionally arranged. Accordingly, each driving module may rotate in a random direction based on the main body.

The driving robot 100 may adjust the rotation directions and the speeds of each driving module by independently controlling the rotation speeds of the plurality of wheels included in each driving module. A rotation direction may mean a direction which the wheels of a driving module are toward. For example, if all driving modules get to rotate by 45 degrees to the right side, the rotation direction of all the driving modules becomes the direction of 45 degrees to the right side. The driving robot 100 may adjust an alignment direction by independently controlling the plurality of wheels included in each of the plurality of driving modules. The driving robot 100 may move in the alignment direction by rotating the plurality of wheels identically while the direction which the plurality of wheels are toward is aligned in one direction. In this case, the direction which the main body is toward may be maintained as it is. In other words, the driving robot 100 may move in any direction without rotating the main body itself.

The driving robot 100 according to the disclosure may set a driving route for performing a given task. According to an embodiment, in case the driving robot 100 needs to carry the loaded object 200 to a destination, the driving robot 100 may set the shortest route to the destination as its driving route. For setting a driving route, the driving robot 100 should correctly identify the location of itself and the location of the destination. Here, the driving robot 100 may measure the current location of the driving robot 100 itself by using initial location information and odometry information. Here, “the initial location information” may mean a location coordinate value (e.g., (10, 3)) of the driving robot 100 when the driving robot 100 started driving.

The odometry information may mean movement information of the driving robot 100. The odometry information may include various types of information such as a moving distance of the driving robot 100, a moving direction of the driving robot 100, the number of times of rotation of the plurality of wheels provided in the driving robot 100, etc. The odometry information may be replaced by various terms such as movement information of the robot, movement data, movement track information, etc.

In other words, if the driving robot 100 is aware of a starting location of driving (X₀), it may obtain odometry information including information on a moving distance and a moving direction of the driving robot 100 whenever it moves, and obtain information on how much change was generated from the starting location of driving (X₀). The driving robot 100 may assume the current location (X₁) of the driving robot 100 by adding a changed amount of the location (add) to the starting location of driving (X₀). The odometry information may be obtained based on information such as the rotation directions, the number of rotation of the wheels, etc. of each driving module. The method of obtaining odometry information will be described in detail again in the parts described below.

Here, the driving robot 100 may obtain odometry information of the main body of the driving robot 100 based on the odometry information of each of the plurality of driving modules provided on the lower side of the driving robot 100. Accordingly, if the odometry information of even just one driving module among the plurality of driving modules does not include correct information on the actual moving distance and moving direction of the driving module, the driving robot 100 cannot correctly obtain the odometry information of the main body of the driving robot 100.

For example, it is assumed that all of the plurality of wheels included in one driving module among the plurality of driving modules are not in contact with the bottom surface. In case a wheel rotates as power is transmitted to the wheel by a motor while the wheel is not in contact with the bottom surface, the rotation of the wheel is detected by a sensor such as an encoder, etc., but as the wheel is not in contact with the bottom surface, it may not influence movement of the driving module including the wheel. Accordingly, even if odometry information of the driving module including the wheel was obtained, the driving module did not actually move by the rotation of the wheel, and thus the odometry information cannot help being incorrect information.

If incorrect odometry information is obtained as described above, the driving robot 100 cannot correctly measure the location of the main body, and accordingly, the driving robot 100 cannot perform functions properly, like the driving robot 100 colliding with an obstacle existing in the driving space or setting a driving route wrongly, etc.

The driving robot 100 according to the disclosure identifies a driving module not in contact with the bottom surface, and generates odometry information of the driving robot 100 only based on odometry information of the other driving modules excluding the odometry information obtained from the driving module not in contact with the bottom surface. Accordingly, the driving robot 100 can obtain correct location information of the driving robot 100.

Also, the driving robot 100 according to the disclosure may rotate the plurality of wheels included in the driving module not in contact with the bottom surface at different rotation speeds. Specifically, there may be a case wherein the bottom surface on which the driving robot 100 drives is bumpy, and thus the plurality of wheels provided in the driving module change from a state of contacting the bottom surface to a state of not contacting the bottom surface, or frequently change from a state of not contacting the bottom surface to a state of contacting the bottom surface. Here, on a moment when the driving module contacts the bottom surface, the driving robot 100 may rotate some wheels among the plurality of wheels at a rotation speed faster than the wheels of the other driving modules, and rotate the remaining wheels among the plurality of wheels at a rotation speed slower than the wheels of the other driving modules. Accordingly, the driving module that was not in contact with the bottom surface may quickly rotate by a targeted rotation angle on a moment of contacting the bottom surface, and this will be described in more detail below.

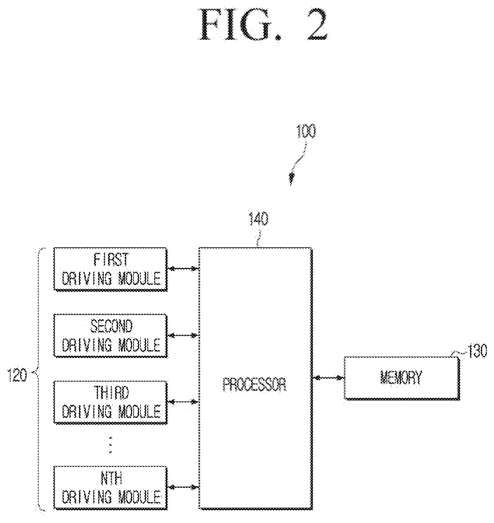

FIG. 2 is a block diagram for illustrating a configuration of a driving robot according to an embodiment of the disclosure.

According to FIG. 2, the driving robot 100 may include a plurality of driving modules 120, memory 130, and at least one processor 140 (hereafter also referred to as “the processor 140”). Each component may be mounted on the main body 110 illustrated in FIG. 1.

The main body 110 may form the exterior of the driving robot 100. For example, in case the driving robot 100 is implemented as an autonomous mobile robot (AMR) used in a manufacturing factory, the main body 110 may consist of a loading part wherein objects can be loaded, a lifting part that can move the loading part wherein objects are loaded in upper and lower directions, etc.

As another example, in case the driving robot 100 is implemented as a cleaning robot, the main body 110 may consist of a suction part that sucks dust or other particles, a wet cleaning part that performs wet cleaning, etc.

As still another example, the driving robot 100 may be implemented as a movable projector. In this case, on the main body 110, a projector part for projecting images, etc. may be arranged.

The aforementioned components are merely examples, and the main body 110 can form various exteriors and include various components according to the use of the driving robot 100.

In the embodiment that will be described below, “movement of the main body 110” may mean “driving of the driving robot 100,” and “a direction in which the main body 110 needs to drive” may mean “a direction in which the driving robot 100 needs to drive.”

The plurality of driving modules 120 may be connected to the lower side of the main body 110, and move the main body 110. Also, each of the plurality of driving modules 120 may include a sensor, a plurality of wheels, and a motor for rotating the plurality of wheels. The driving modules 120 may also be referred to as a differential module.

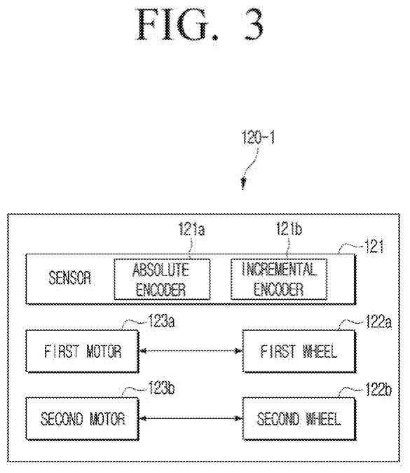

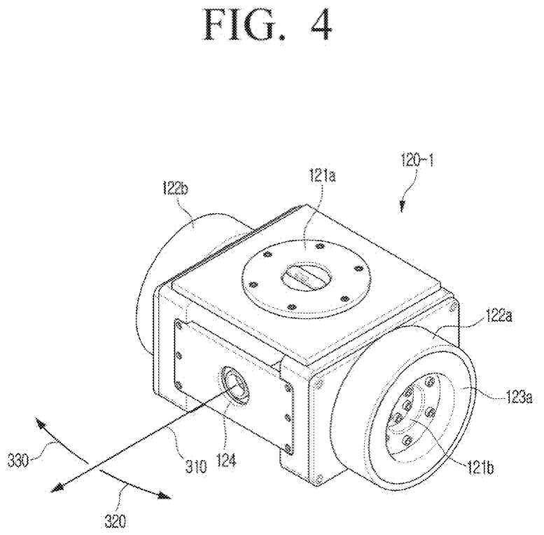

The plurality of driving modules 120 are driven according to a control signal of the processor 140. For example, the processor 140 may drive the motor to rotate the plurality of wheels included in each of the plurality of driving modules 120 for moving the main body 110 along a predetermined driving route. The configurations and the operations of the plurality of driving modules 120 will be described in detail in the explanation parts for FIG. 3 and FIG. 4 that will be described below.

The memory 130 may store location information and odometry information of the driving robot 100. Also, the memory 130 may store at least one instruction regarding the driving robot 100, an operating system (O/S) for driving the driving robot 100, or other software modules, applications, data, etc. In addition, the memory 130 may store volatile memory such as a frame buffer, semiconductor memory such as flash memory, etc., or a magnetic storage medium such as a hard disk, etc.

The processor 140 may control the operations of the driving robot 100 by executing the various types of software modules stored in the memory 130. In the disclosure, the term “memory” may be used as a meaning including the memory 130, read-only memory (ROM) and random-access memory (RAM) inside the processor 140, or a memory card (e.g., a micro SD card, a memory stick) mounted on the driving robot 100.

The processor 140 may be connected with the main body 110, the plurality of driving modules 120, and the memory 130, and control overall operations and functions of the driving robot 100.

The processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 140 may control one or a random combination of the other components of the driving robot 100, and perform an operation related to communication or data processing. Also, the at least one processor 140 may execute one or more programs or instructions stored in the memory 130. For example, the at least one processor 140 may perform the method according to an embodiment of the disclosure by executing the one or more instructions stored in the memory 130.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 140 may be implemented as a single core processor including one core, or it may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor 140 may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

The processor 140 may determine the rotation directions of each of the plurality of driving modules 120 based on a direction in which the main body 110 needs to drive and a characteristic of a route. Here, “determining the rotation directions of each of the plurality of driving modules 120 based on a direction in which the main body 110 needs to drive and a characteristic of a route” may include determining the rotation directions of each of the plurality of driving modules 120 based on a direction in which the main body 110 needs to drive (i.e., forward, backward, a direction of 30 degrees to the right side, a direction of 45 degrees to the left side, etc.) or a characteristic of a route (e.g., straight-line movement, curved-line movement).

The processor 140 may rotate each of the plurality of driving modules 120 to fit the determined rotation directions. When wheels of each driving module rotate while each of the plurality of driving modules 120 rotated to fit the determined rotation directions, the main body 110 gets to drive in the direction in which it needs to drive (i.e., the driving direction). If the wheels of the plurality of driving modules 120 rotate while at least one driving module is toward a direction different from the determined rotation direction, the driving robot 100 may deviate from the driving route or a normal position.

At the time of straight-line movement of the main body 110, the processor 140 may simultaneously rotate the wheels while all of the wheels of the plurality of driving modules 120 are aligned in the same direction (e.g., forward, 20 degrees to the right side, 90 degrees to the right side, etc.). According to a rotation movement of the wheels, the main body 110 may drive in the alignment direction.

At the time of curved-line movement of the main body 110, the processor 140 may simultaneously rotate the wheels while the directions of the plurality of driving modules 120 were respectively rotated in different directions (e.g., a forward driving module was rotated by 45 degrees to the right side, a backward driving module was rotated by 10 degrees to the right side) based on the direction in which the main body 110 needs to drive. According to the rotation movement of the wheels, the main body 110 may drive on a curved route.

For example, in case the driving robot 100 needs to drive in a straight line, i.e., in a first direction while the front surface of the main body 110 is toward the first direction, the processor 140 may control the plurality of driving modules 120 such that the plurality of wheels included in each of the plurality of driving modules 120 can rotate while all of the wheels of the plurality of driving modules 120 are aligned to be toward the first direction. Accordingly, the main body 110 gets to move in the first direction. Here, the feature that “a driving module is aligned in a forward direction” may mean that the front surface part of the driving module is toward the same direction as the front surface of the main body 110.

As still another example, in case the driving robot 100 needs to drive on a curved route in a second direction (e.g., a right direction) different from the first direction while the front surface of the main body 110 is toward the first direction, the processor 140 may determine the rotation directions of each of the plurality of driving modules 120 based on the curved route on which the main body 110 needs to drive. Specifically, if one driving module is provided on each of the front right side, the front left side, the rear right side, and the rear left side on the lower side of the main body 110, for driving on a curved route rotated in a right direction, the processor 140 may determine the rotation directions of each of the plurality of driving modules 120 such that a driving module provided on the front side rotates to the right side based on the front side, and a driving module provided on the rear side rotates to the left side based on the front side. Here, the feature that “a driving module rotates to the right side/the left side based on the front side” may mean that the front surface part of the driving module rotates in a clockwise direction/a counter-clockwise direction, and a rotation direction of a driving module will be defined in the explanation part for FIG. 4 that will be described below.

Also, the processor 140 may identify at least one driving module that is not in contact with the bottom surface among the plurality of driving modules 120 based on sensing values of the sensors included in each of the plurality of driving modules 120, and control the motor to rotate the plurality of wheels included in the identified at least one driving module at different rotation speeds.

Here, “a driving module that is not in contact with the bottom surface” may mean a state wherein the plurality of wheels included in the driving module are not in contact with the bottom surface. In the explanation that will be described below, for the convenience of explanation, “a driving module including at least one wheel that is not in contact with the bottom surface” will be referred to as “a driving module that is not in contact with the bottom surface.”

Detailed components of the driving modules such as the sensors and the plurality of wheels, etc. of the plurality of driving modules 120 will be described in detail in the explanation for FIG. 3 and FIG. 4 that will be described below.

FIG. 3 is a block diagram for illustrating a configuration of a driving module according to an embodiment of the disclosure, and FIG. 4 is a diagram for illustrating a configuration of a driving module according to an embodiment of the disclosure.

According to FIG. 3 and FIG. 4, one driving module 120-1 may include a sensor 121, a plurality of wheels 122, and a plurality of motors 123 rotating each of the plurality of wheels.

The sensor 121 may sense a moving distance and a moving direction of the driving module 120-1.

For sensing a moving direction of the driving module 120-1, the sensor 121 may include an absolute encoder 121a. As illustrated in FIG. 4, the absolute encoder 121a may be provided in the upper part of the driving module 120-1. The processor 140 can correctly identify a rotation angle of the driving module 120-1 based on a sensing value of the absolute encoder 121a. Specifically, the absolute encoder 121a may output data regarding how much a rotation disk rotated by scanning a location code that was binary-encoded optically on the rotation disk, and the processor 140 may identify the direction in which the driving module 120-1 rotated based on the data output from the absolute encoder 121a.

FIG. 4 illustrated that the absolute encoder 121a is provided in the upper part of the driving module 120-1, but this is merely an example, and the disclosure is not limited thereto, and the absolute encoder 121a can be provided in various locations wherein an angle by which the driving module 120-1 was rotated can be sensed.

Also, for sensing of a moving distance of the driving module 120-1, the sensor 121 may include an incremental encoder 121b. As illustrated in FIG. 4, the incremental encoder 121b may be provided on a wheel 122 of the driving module 120-1. The processor 140 can correctly identify the number of rotation of the wheel 122 through the incremental encoder 121b. Specifically, when the rotation disk rotates, the incremental encoder 121b may optically count the number of slots arranged on the circumference of the rotation disk by a specific interval and output the counted number, and the processor 140 can correctly identify the number of rotation of the wheel 122 based on the value output from the incremental encoder 121b. The processor 140 can calculate the distance that the driving module 120-1 moved based on the identified number of rotation of the wheel 122.

In the explanation described above, only a case wherein the sensor 121 includes the absolute encoder 121a and the incremental encoder 121b was suggested, but the sensor 121 may include various sensors that can detect a moving distance and a moving direction of the driving module 120-1. For example, the sensor 121 may include a magnetic encoder, and detect the number of rotation and the rotation direction of the wheel 122 through the magnetic encoder.

Other than the above, the sensor 121 may include various types of sensors such as a contact sensor, an ultrasonic sensor, an infrared sensor, etc., and identify whether the wheel 122 is in contact with the bottom surface through this. For example, in case the sensor 121 includes a contact sensor, the processor 140 may detect contact between the wheel 122 and the ground surface through the contact sensor, and in case contact between the wheel 122 and the ground surface is not detected, the processor 140 may identify the driving module including the wheel as a driving module that is not in contact with the bottom surface.

As illustrated in FIG. 4, the plurality of wheels 122 may include a first wheel 122a provided on the left side of the driving module 120-1, and a second wheel 122b provided on the right side. The first wheel 122a and the second wheel 122b may be connected with each other by a center axis that penetrates the driving module 120-1. Through such connection, even if only one wheel between the first wheel 122a and the second wheel 122b contacts the bottom surface, the remaining wheel may also get in a state of contacting the bottom surface by the connection by the axis penetrating the driving module 120-1.

The plurality of wheels 122 may receive power from the motor 123 and rotate in a clockwise direction and a counter-clockwise direction, and rotate at various speeds.

FIG. 3 and FIG. 4 illustrated that one wheel is provided on each of the left side and the right side of the driving module 120-1, but this is merely an example, and it is obvious that two or more wheels can be provided on each of the left side and the right side of the one driving module 120-1.

As illustrated in FIG. 4, the plurality of motors 123 may be provided in forms of in-wheel motors inside the plurality of wheels 122. In other words, the first motor 123a may be provided inside the first wheel 122a, and the second motor 123b may be provided inside the second wheel 122b. As the first motor 123a and the second motor 123b are respectively provided inside the first wheel 122a and the second wheel 122b, the plurality of motors 123 may rotate each of the plurality of wheels 122 at different rotation speeds. In other words, the plurality of motors 123 may be implemented in forms of in-wheel motors in each of the plurality of wheels 122 of the driving module 120-1, and may independently provide power to each wheel through this.

For example, the processor 140 may control the first motor 123a to provide torque of 30 Nm to the first wheel 122a, and control the second motor 123b to provide torque of 50 Nm to the second wheel 122b, and may thereby control such that the second wheel 122b rotates faster than the first wheel 122a.

In the explanation described above, it was only suggested that the plurality of motors 123 may be implemented in forms of in-wheel motors, but this is merely an example, and the plurality of motors 123 may be implemented through various motors that provide different power to each of one or more wheels through one axis.

In the disclosure, a direction which the front surface part 124 of the driving module 120-1 is toward means a reference axis 310 that defines a rotation direction of the driving module 120-1. Accordingly, if the first wheel 122a provided on the left side of the driving module 120-1 rotated at a rotation speed faster than the second wheel 122b provided on the right side, and the front surface part 124 of the driving module 120-1 rotated to be toward the right side, it will be defined that the driving module 120-1 rotated in a clockwise direction 330 or to the right side. In contrast, if the second wheel 122b provided on the right side of the driving module 120-1 rotated at a rotation speed faster than the first wheel 122a provided on the left side, and the front surface part 124 of the driving module 120-1 got to be toward the left side, it will be defined that the driving module 120-1 rotated in a counter-clockwise direction 320 or to the left side.

The processor 140 may perform various operations such as identifying a driving module not in contact with the bottom surface or rotating a driving module, etc. by controlling the detailed components of the driving module 120-1 as described above. Detailed explanation in this regard will be described in the explanation parts for the drawings that will be described below.

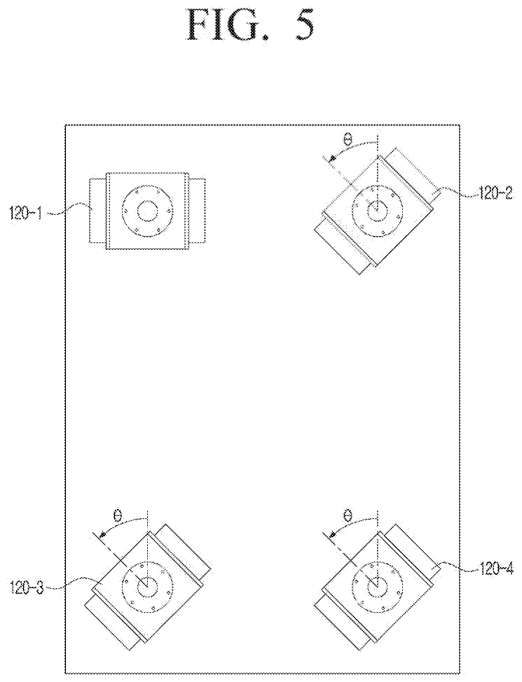

FIG. 5 is a diagram for illustrating a method of identifying a driving module that is not in contact with a bottom surface of a driving robot according to an embodiment of the disclosure.

According to FIG. 5, the processor 140 may identify a driving module 120-1 that is not in contact with the bottom surface among a plurality of driving modules 120-1, 120-2, 120-3, 120-4.

The processor 140 may identify whether the driving module 120-1 is in contact with the bottom surface based on a sensing value of the sensor 121. Specifically, the processor 140 identifies whether the driving module 120-1 is not in contact with the bottom surface by detecting a direction in which the driving module 120-1 rotated based on an output value of the absolute encoder 121a, and identifying whether the rotation direction of the driving module 120-1 coincides with a rotation direction determined based on a direction in which the main body 110 needs to drive.

In order that the processor 140 rotates the driving module 120-1 in the rotation direction determined based on the direction in which the main body 110 needs to drive, the processor 140 needs to rotate the direction in which the front surface part 124 is toward by rotating each of the plurality of wheels 122 at different rotation speeds. For example, if the processor 140 needs to rotate the direction in which the front surface part 124 of the driving module 120-1 is toward as much as θ to the left side, the processor 140 may rotate the second wheel 122b provided on the right side of the driving module 120-1 at fast speed, and rotate the first wheel 122a provided on the left side at relatively slower speed.

Rotation of the driving module 120-1 due to a difference in rotation speeds of the wheels as described above is a control method that is possible only in a state wherein all of the plurality of wheels 122 are in contact with the bottom surface. Accordingly, even if the processor 140 controlled the rotation speeds of the plurality of wheels 122 provided in the driving module 120-1 at different speeds, if the driving module 120-1 is not rotated in the rotation direction determined based on the direction in which the main body 110 needs to drive, the processor 140 may identify the driving module 120-1 as a driving module that is not in contact with the bottom surface.

According to FIG. 5, in order that the main body 110 drives along a driving route, each of the plurality of driving modules 120 should be rotated in the rotation direction determined based on the direction in which the main body 110 needs to drive. As illustrated in FIG. 5, only when all of the plurality of driving modules 120 get in a state of having rotated in a counter-clockwise (or left) direction as much as θ, the main body 110 can drive along a straight driving route. Here, all of the second, third, and fourth driving modules 120-2, 120-3, and 120-4 rotated in a counter-clockwise direction as much as θ by being controlled by the processor 140, and thus the processor 140 may identify that the second, third, and fourth driving modules 120-2, 120-3, and 120-4 are in contact with the bottom surface. In contrast, as the first driving module 120-1 did not rotate in a counter-clockwise direction as much as θ, the processor 140 may identify the first driving module 120-1 as a driving module that is not in contact with the bottom surface.

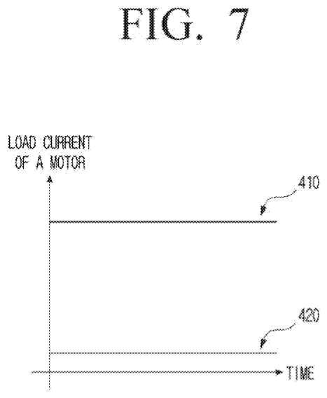

Also, the processor 140 may identify whether the driving module 120-1 is a driving module that is not in contact with the bottom surface based on a load currents of the plurality of motors 123. Detailed explanation in this regard will be described in the explanation part for FIG. 7.

In the explanation described above, only a method by which the processor 140 identifies whether the driving module 120-1 is a driving module that is not in contact with the bottom surface based on the rotation direction of the driving module 120-1 detected through an output value of the absolute encoder 121a was explained, but this is merely an example, and the processor 140 may identify whether the driving module 120-1 is a driving module that is not in contact with the bottom surface through various sensors that can identify whether the driving module 120-1 contacted the bottom surface such as a contact sensor, an ultrasonic sensor, an infrared sensor, etc.

Also, in case the driving module 120-1 that is not in contact with the bottom surface was identified, the processor 140 may identify the location of the main body 110 excluding the odometry information obtained through the sensor 121 included in the identified driving module 120-1.

In the disclosure, odometry information of the main body 110 obtained by the processor 140 in case the plurality of entire driving modules 120 are in contact with the bottom surface will be defined as the first odometry information, and odometry information of the main body 110 obtained by the processor 140 in case at least one driving module is not in contact with the bottom surface will be defined as the second odometry information.

In case the plurality of entire driving modules 120 are in contact with the bottom surface, rotation movements of all the wheels provided in the plurality of driving modules 120 influence the movement of the main body 110. Accordingly, the processor 140 obtains the first odometry information based on the odometry information of the plurality of driving modules 120. Specifically, the processor 140 may obtain odometry information of each of the plurality of driving modules 120 including information on the directions in which each of the plurality of driving modules 120-1, 120-2, 120-3, and 120-4 moved, and the distances they moved, and obtain the first odometry information based on the obtained odometry information and a formula.

As an example, the processor 140 may obtain the first odometry information by using a formula as follows.

$$[ \begin{matrix}{\dot{O}}_{0} \\ \dot{θ}\end{matrix} ] = h ( {θ}_{1} , {θ}_{2} , {θ}_{3} , {θ}_{4} ) [ \begin{matrix}\begin{matrix}\begin{matrix}{v}_{1} \\ {v}_{2}\end{matrix} \\ {v}_{3}\end{matrix} \\ {v}_{4}\end{matrix} ] \qquad [ Formula 1 ]$$

In the formula 1, \dot{O}₀ constituting the matrix existing on the left side may mean a changed amount of the location of the main body 110, and \dot{θ} may mean a changed amount of the moving direction of the main body 110. Also, in the formula 1, the variables θ₁θ₂,θ₃,θ₄ existing on the right side may respectively mean the angles by which the first, second, third, and fourth driving modules rotated, and ν₁, ν₂, ν₃, ν₄ may respectively mean the speeds at which the first, second, third, and fourth driving modules moved.

Accordingly, the processor 140 may obtain the changed amount of the location of the main body 110 (\dot{O}₀) and the changed amount of the moving direction of the main body 110 (\dot{θ}) by inputting the rotation angles of each of the plurality of driving modules (θ₁, θ₂, θ₃, θ₄) and the moving speeds of each of the plurality of driving modules (ν₁, ν₂, ν₃, ν₄) into the formula 1.

The formula 1 may be a formula that the designer or a user of the driving robot 100 defined in advance in consideration of the locational relation between the main body 110 and the plurality of driving modules 120. As the formula 1 is merely an example, the processor 140 may obtain the first odometry information based on other various formulae.

In contrast, in case the driving module 120-1 that is not in contact with the bottom surface exists, rotation movements of the plurality of wheels 122 provided in the driving module 120-1 that is not in contact with the bottom surface cannot influence the movement of the main body 110. Accordingly, information such as the rotation direction of the driving module 120-1 and the number of rotation of the plurality of wheels 122 obtained through the absolute encoder 121a and the incremental encoder 121b of the driving module 120-1 that is not in contact with the bottom surface is information that is totally not related to the movement of the main body 110, and thus the processor 140 may obtain the second odometry information based on the odometry information of the second, third, and fourth driving modules 120-2, 120-3, and 120-4 excluding the driving module 120-1 that is not in contact with the bottom surface and a formula.

As an example, the processor 140 may obtain the second odometry information by using a formula as follows.

$$[ \begin{matrix}{\dot{O}}_{0} \\ \dot{θ}\end{matrix} ] = h ( {θ}_{2} , {θ}_{3} , {θ}_{4} ) [ \begin{matrix}\begin{matrix}{v}_{2} \\ {v}_{3}\end{matrix} \\ {v}_{4}\end{matrix} ] \qquad [ Formula 2 ]$$

In the formula 2, in the same manner as in the formula 1, \dot{O}₀ constituting the matrix existing on the left side may mean a changed amount of the location of the main body 110, and \dot{θ} may mean a changed amount of the moving direction of the main body 110. However, in the formula 2, the variables θ₂, θ₃, θ₄ existing on the right side may respectively mean the angles by which the second, third, and fourth driving modules rotated, and ν₂, ν₃, ν₄ may respectively mean the speeds at which the second, third, and fourth driving modules moved. In other words, compared with the formula 1, in the formula 2, the rotation angle value and the moving speed value of the first driving module are not included.

Accordingly, the processor 140 may obtain the changed amount of the location of the main body 110 (\dot{O}₀) and the changed amount of the moving direction of the main body 110 (\dot{θ}) by inputting the rotation angles of each of the remaining driving modules (θ₂, θ₃, θ₄) excluding the first driving module that is not in contact with the bottom surface and their moving speeds (ν₂, ν₃, ν₄) into the formula 2.

The formula 2 may be a formula that the designer or a user of the driving robot 100 defined in advance in consideration of the locational relation between the main body 110 and the plurality of driving modules 120. As the formula 2 is merely an example, the processor 140 may obtain the second odometry information based on other various formulae.

Also, the processor 140 may store the first odometry information and the second odometry information in the memory 130, and identify the location of the main body 110 based on the odometry information stored in the memory 130. Specifically, in the memory 130, initial location (X₀) information of the main body 110 may have been stored, and the processor 140 may identify a new location (X₁) of the main body 110 by reflecting the odometry information including the information on the distance and the direction in which the main body 110 moved to the initial location (X₀) of the main body 110 stored in the memory 130.

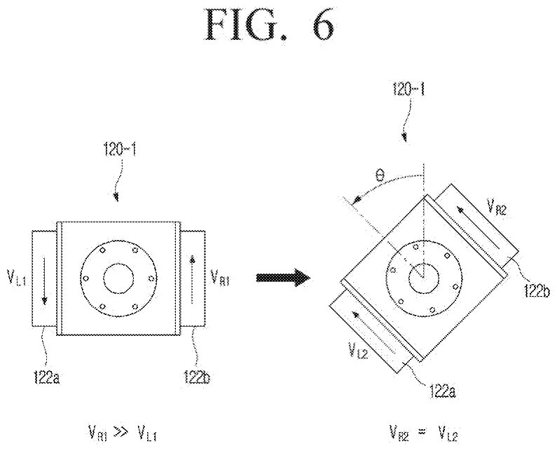

In addition, when the driving module 120-1 that is not in contact with the bottom surface is identified, the processor 140 may control the motor such that the plurality of wheels of the identified driving module 120-1 rotate at different rotation speeds, and detailed explanation in this regard will be described in the explanation part for FIG. 6.

FIG. 6 is a diagram for illustrating a method of controlling a plurality of wheels of a driving robot according to an embodiment of the disclosure.

According to FIG. 6, the processor 140 may control the rotation speeds of the plurality of wheels 122 provided in the driving module 120-1 that is not in contact with the bottom surface to be different from one another.

Returning to FIG. 5, the processor 140 may identify the driving module 120-1 that did not rotate as much as θ in a counter-clockwise direction as a driving module that is not in contact with the bottom surface, and intend to rotate the driving module 120-1 fast as much as θ in a counter-clockwise direction for driving of the main body 110.

For example, a case wherein the bottom surface on which the driving robot 100 drives is bumpy is assumed. In case the height of the bottom surface becomes suddenly low and then becomes high, some driving modules 120-1 among the plurality of driving modules 120 may momentarily get detached from the bottom surface and then contact the bottom surface again. On a moment of getting detached from the bottom surface, the processor 140 cannot control the rotation direction of the driving module 120-1, and accordingly, as illustrated in FIG. 5, the driving module 120-1 may get in a state of not having rotated in the determined rotation direction momentarily. The processor 140 may control the plurality of wheels provided in the driving module 120-1 to rotate at different rotation speeds so that the driving module 120-1 can rotate in the determined rotation direction fast.

Here, among the plurality of wheels 122 provided in the driving module 120-1 that is not in contact with the bottom surface, the processor 140 may rotate a wheel arranged on the opposite side based on the rotation direction determined for the driving module 120-1 at a faster speed than the rotation speeds of the wheels provided in the remaining driving modules 120-2, 120-3, and 120-4, and rotate a wheel arranged in the rotation direction determined for the driving module 120-1 among the plurality of wheels provided in the driving module 120-1 at a slower speed than the rotation speeds of the wheels provided in the remaining driving modules 120-2, 120-3, and 120-4.

Specifically, as illustrated in FIG. 5, if the main body 110 needs to drive on a straight route in the left direction, all of the driving modules 120-1, 120-2, 120-3, and 120-4 should be aligned in a direction that was rotated to the left side as much as θ, but the driving module 120-1 that is not in contact with the bottom surface may not be rotated to the left side as much as θ. For rotating the driving module 120-1 to the left side as much as θ, the processor 140 may control the second wheel 122b arranged on the opposite side (the right side) of the determined rotation direction (the left side) to rotate at a speed (V_{R1}) faster than the rotation speeds of the remaining wheels, and control the first wheel 122a arranged in the determined rotation direction (the left side) to rotate at a speed (V_{L1}) slower than the rotation speeds of the remaining wheels.

As the rotation speed (V_{R1}) of the second wheel 122b arranged on the opposite side of the determined rotation direction is greater than the rotation speed (V_{L1}) of the first wheel 122a arranged in the determined rotation direction (V_{R1}>>V_{L1}), when the driving module 120-1 gets to contact the bottom surface again, the driving module 120-1 may rotate to the left side fast due to the difference in the rotation speeds of the wheels.

If it is identified that the driving module 120-1 that is not in contact with the bottom surface rotated again in the determined rotation direction by the aforementioned control operation, the processor 140 may control the plurality of motors 123 such that the plurality of wheels 122 provided in the driving module 120-1 rotate at the same rotation speed.

Specifically, the processor 140 may identify whether the driving module 120-1 is in a state of having rotated to the left side as much as θ based on a sensing value of the sensor 121 including the absolute encoder 121a. If it is identified that the driving module 120-1 did not rotate to the left side as much as θ, the processor 140 may make each of the plurality of wheels 122 rotate at different rotation speeds.

In contrast, if it is identified that the driving module 120-1 rotated to the left side as much as θ, the processor 140 may control the plurality of motors such that the plurality of wheels 122 rotate at the same rotation speed (V_{R2}=V_{L2}), and thereby control the driving module 120-1 to not rotate anymore. If the respective wheels provided on the right side and the left side among the plurality of wheels 122 rotate at the same rotation speed (V_{R2}=V_{L2}), there is no difference in the rotation speeds and accordingly, the driving module 120-1 does not rotate, and thus the processor 140 may control the plurality of motors 123 such that the plurality of wheels 122 rotate at the same speed after the driving module 120-1 rotated in the determined rotation direction.

In the aforementioned explanation, it was only described that it can be identified whether a driving module was aligned by the sensor 121 including the absolute encoder 121a, but this is merely an example, and it can be identified whether a driving module was aligned through various sensors that can detect a moving direction of the driving module such as the incremental encoder 121b, a hall sensor, etc.

For example, if a small magnet is attached to a wheel of a driving module, the hall sensor can detect a change of the magnetic field whenever the wheel rotates, and the processor 140 may identify in which direction the driving module is moving through the phase of the change of the magnetic field detected by the hall sensor.

FIG. 7 is a diagram for illustrating a method of identifying a driving module that is not in contact with a bottom surface of a driving robot according to an embodiment of the disclosure.

According to FIG. 7, load currents of the motors provided in each of the plurality of driving modules 120 may vary according to the state of the bottom surface, and a load current 410 of a motor when a driving module is in contact with the bottom surface may be much bigger than a load current 420 of the motor when the driving module is not in contact with the bottom surface.

Here, a load current of a motor may mean a current that is consumed by the motor for driving the wheels provided in the driving module 120-1, and may influence the rotation speed of the wheels. For example, for rotating a wheel at 10 (rad/sec), a motor load current of 80 (mA) may be consumed, and for rotating a wheel at 30 (rad/sec) which is faster, a motor load current of 240 (mA) may be consumed.

Here, a load current value of a motor may vary according to the size of physical resistance applied to a wheel. For example, even in the case of the same situation wherein a motor needs to control a rotation speed of a wheel at 10 (rad/sec), in case the wheel is placed on a slick bottom surface, a load current of 80 (mA) may be consumed, but in case the wheel is placed on a sticky bottom surface, the resistance of the bottom surface is strong, and thus a load current of 200 (mA) may be consumed. In case the wheel is not in contact with the bottom surface, resistance between the wheel and the bottom surface does not exist, but only air resistance exists, and thus the load current of the motor may become very low. Here, the processor 140 may measure the load current of the motor by measuring a current or a voltage flowing on the motor side through an ammeter or a voltmeter, etc.

If it is identified that a load current of a motor provided in at least one driving module among the plurality of driving modules 120 became smaller than load currents of motors provided in the remaining driving modules by greater than or equal to a predetermined amount, the processor 140 may identify the driving module wherein the load current of the motor became smaller by greater than or equal to the predetermined amount as a driving module that is not in contact with the bottom surface.

For example, it is assumed that a current value of a predetermined amount is 100 (mA). If the load current of the motors provided in the second, third, and fourth driving modules 120-2, 120-3, and 120-4 is 150 (mA) whereas the load current of the motor provided in the first driving module 120-1 is 30 (mA), the load current value of the motor provided in the first driving module 120-1 is smaller than the load current of the motors provided in the remaining driving modules 120-2, 120-3, and 120-4 by more than 100 (mA), and thus the processor 140 may identify the first driving module 120-1 as a driving module that is not in contact with the bottom surface.

Also, in case it was identified that a load current of a motor decreased to be smaller than a predetermined value, the processor 140 may identify a driving module including the motor wherein the load current decreased to be smaller than the predetermined value as a driving module that is not in contact with the bottom surface.

For example, in case the predetermined value is 30 (mA), the processor 140 may identify a motor wherein the load current value decreased to be smaller than 30 (mA) without comparing it with the load currents of the motors provided in the other driving modules, and identify the driving module including the motor as a driving module that is not in contact with the bottom surface.

‘The predetermined amount’ and ‘the predetermined value’ described above may be designated as various values according to the setting of the developer of the driving robot 100, and they can vary according to the weight of the load that is loaded on the driving robot 100.

As described above, the processor 140 may identify a driving module that is not in contact with the bottom surface based on a load current value of a motor, and for the driving module that is not in contact with the bottom surface, the processor 140 may rotate it in the rotation direction determined based on the direction in which the main body 110 needs to drive by controlling the rotation speeds of each of the plurality of wheels differently as explained in FIG. 5 and FIG. 6.

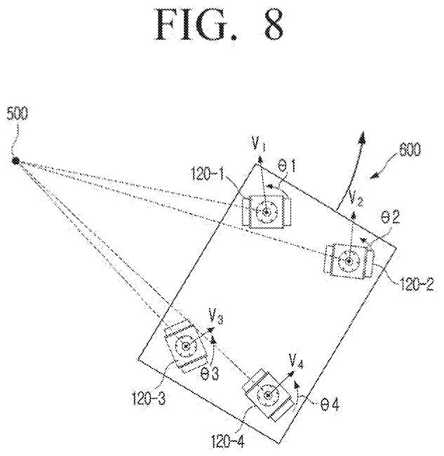

FIG. 8 is a diagram for illustrating a method of driving on a curved route of a driving robot according to an embodiment of the disclosure.

According to FIG. 8, in case the main body 110 needs to drive on a curved route 600, the processor 140 may determine the rotation directions of each of the plurality of driving modules 120 based on the direction of the main body 110 and the characteristic of the curved route. The processor 140 may control the plurality of driving modules 120 to move in different directions and speeds based on the determined rotation direction.

Returning to FIG. 5, when the main body 110 drives on a straight route without a rotation of the main body 110, the processor 140 may control the plurality of driving modules 120 to all move in the same direction and the same speed.

Accordingly, if the driving route of the main body 110 is a straight route as illustrated in FIG. 5, all of the plurality of driving modules should be aligned in the same direction, and accordingly, in case the driving module 120-1 that is not in contact with the bottom surface was identified, the processor 140 may control the motor such that each of the plurality of wheels provided in the driving module 120-1 rotates at a different rotation speed until the driving module 120-1 that is not in contact with the bottom surface is aligned identically to the alignment direction of the remaining driving modules.

Also, if it is identified that the driving module 120-1 that is not in contact with the bottom surface is aligned with the other driving modules, the processor 140 may control the motor such that the plurality of wheels provided in the driving module 120-1 rotate at the same rotation speed as the rotation speeds of the wheels provided in the other driving modules.

As the control of the rotation speeds of the wheels described above operates by the method as explained in FIG. 3 to FIG. 6, explanation in that regard will be omitted.

In contrast, as illustrated in FIG. 8, if the driving route of the main body 110 is the curved route 600, and thus the main body 110 needs to rotate together along the driving route, for the main body 110 to drive on the curved route 600 normally, the processor 140 may set different target directions and target velocity for each of the plurality of driving modules 120.

Here, the target directions may mean the rotation directions in which each of the plurality of driving modules 120 needs to rotate for the main body 110 to drive on the curved route 600 normally, and the target velocity may mean the rotation velocity at which the plurality of wheels included in each of the plurality of driving modules 120 need to rotate for the main body 110 to drive on the curved route 600 normally. The target directions and the target velocity may be set based on relations between the location of the center of rotation 500 of the curved route 600 and the locations of each of the driving modules. Here, the center of rotation may mean a center point wherein the curved line rotates. In other words, when viewing the curved route as an arc of a circle, the point that becomes the center of the circle may be defined as the center of rotation 500.

For example, while the first driving module 120-1 is located relatively close to the center of rotation 500, the second driving module 120-2 is located relatively far from the center of rotation 500. Thus, while the first driving module 120-1 moves a short distance while the main body 110 is driving on the curved route 600, the second driving module 120-2 needs to move a longer distance. Accordingly, the processor 140 may set the target velocity of the second driving module 120-2 to be faster than the target velocity of the first driving module 120-1. Also, based on the fact that the first driving module 120-1 is located relatively close to the center of rotation 500, the processor 140 may set the target direction such that the first driving module 120-1 rotates to the left side by a bigger angle (01), and based on the fact that the second driving module 120-2 is located relatively far from the center of rotation 500, the processor 140 may set the target direction such that the second driving module 120-2 rotates to the left side by a smaller angle (02).

According to an embodiment, when a route on which the main body 110 needs to drive is a curved route, in case the driving module 120-1 that is not in contact with the bottom surface was identified, the processor 140 may control the motor such that the plurality of wheels provided in the driving module 120-1 rotate at different rotation speeds until the driving module 120-1 that is not in contact with the bottom surface is aligned in the target direction. Also, if it is identified that the driving module 120-1 was aligned in the target direction, the processor 140 may control the motor such that all of the plurality of wheels provided in the driving module 120-1 rotate at the same target velocity.

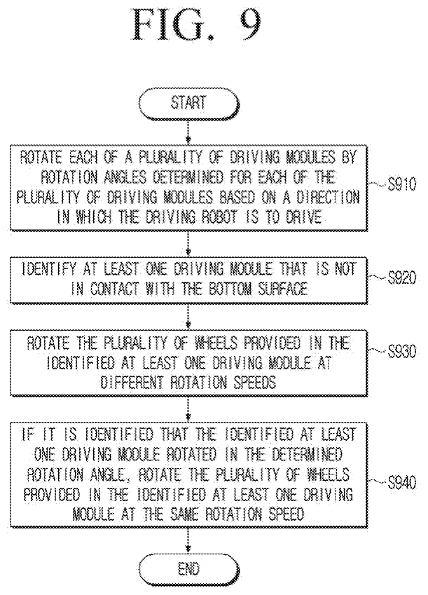

FIG. 9 is a flow chart for illustrating a driving method of a driving robot according to an embodiment of the disclosure.

According to FIG. 9, the driving robot may rotate each of a plurality of driving modules by rotation angles determined for each of the plurality of driving modules based on a direction in which the main body needs to drive in the step S910.

For example, if a direction and a route in which the main body needs to drive is a straight route in the left direction, all of the plurality of driving modules may be aligned to rotate by a certain angle to the left side. According to another embodiment, if a direction and a route in which the main body needs to drive is a curved route in the left direction, the rotation angles of each of the plurality of driving modules may be set all differently based on the relation between the locations of each of the plurality of driving modules and the location of the center of rotation of the curved route, and each of the plurality of driving modules may rotate according to their respective rotation angles.

Then, the driving robot may identify at least one driving module that is not in contact with the bottom surface in the step S920.

For example, if it is identified that a load current of a motor included in at least one driving module among the plurality of driving modules became smaller than load currents of the motors of the remaining driving modules by greater than or equal to a predetermined amount, the driving robot may identify the driving module including the identified motor as the driving module that is not in contact with the bottom surface.

According to another embodiment, based on output values of absolute encoders included in each of the plurality of driving modules, if a driving module that was not aligned in the rotation angle determined based on the direction in which the main body needs to drive is identified among the plurality of driving modules, the driving robot may identify the identified driving module as the driving module that is not in contact with the bottom surface.

Then, the driving robot may rotate the plurality of wheels provided in the at least one driving module identified as the driving module that is not in contact with the bottom surface at different rotation speeds in the step S930.

For example, among the plurality of wheels provided in the at least one driving module identified as the driving module that is not in contact with the bottom surface, the driving robot may rotate a wheel arranged on an opposite side based on the determined rotation direction at a speed faster than the rotation speeds of the wheels provided in the remaining driving modules, and rotate a wheel arranged on the same side as the determined rotation direction among the plurality of wheels at a speed slower than the rotation speeds of the wheels provided in the remaining driving modules.

Then, if it is identified that the driving module identified as the driving module that is not in contact with the bottom surface rotated again in the determined rotation angle, the driving robot may rotate the plurality of wheels provided in the driving module at the same rotation speed in the step S940.

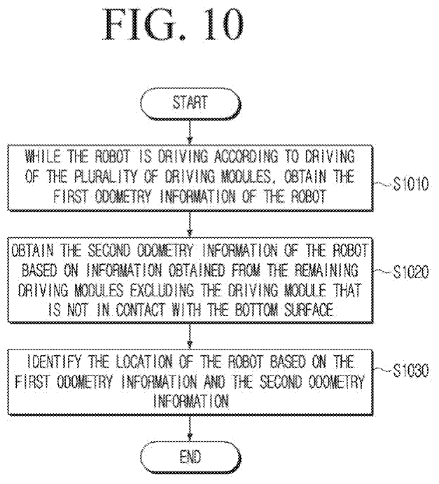

FIG. 10 is a flow chart for illustrating a method of identifying a location of a driving robot according to an embodiment of the disclosure.

According to FIG. 10, while the main body of the driving robot is driving according to driving of the plurality of driving modules, the driving robot may obtain the first odometry information of the main body in the step S1010.

Here, the first odometry information may mean odometry information of the main body that is obtained by the driving robot in case the plurality of entire driving modules are in contact with the bottom surface.

Then, the driving module may obtain the second odometry information of the main body based on information obtained from the remaining driving modules excluding the driving module that is not in contact with the bottom surface in the step S1020.

Here, the second odometry information may mean odometry information of the main body that is obtained by the driving robot in case at least one driving module among the plurality of driving modules is not in contact with the bottom surface.

Then, the driving robot may identify the location of the main body based on the first and second odometry information in the step S1030.

For example, the driving robot may store initial location information (X₀) of the main body, and the driving robot may identify a new location (X₁) of the main body by reflecting the first and second odometry information including information on the distance and the direction in which the main body moved to the stored initial location (X₀) of the main body.

The various kinds of methods explained in FIG. 9 and FIG. 10 may be performed by a driving robot having the configuration illustrated in FIG. 2 or FIG. 3, but are not necessarily limited thereto, and they may be performed by driving robots having various configurations.

In the above, it was explained that a driving module includes a plurality of wheels and may drive the main body by independently controlling the plurality of wheels, but a driving robot may be implemented in a form wherein a driving module includes only one wheel. In this case, a rotatable hinge may be provided in a connecting part of the driving module and the main body, and the driving robot may be implemented in a form wherein the driving module does not rotate based on a difference in the rotation speeds of a plurality of wheels provided in the driving module as explained above, but the driving module rotates through a hinge that can directly rotate the driving module.

In the above, various embodiments were explained independently or in combination, but each embodiment is not necessarily implemented solely. In other words, the aforementioned various embodiments may be combined with at least one other embodiment on the whole or partially, and implemented together in one product.

The methods according to the aforementioned various embodiments of the disclosure may be implemented in forms of applications that can be installed on conventional driving robots.

Also, the methods according to the aforementioned various embodiments of the disclosure may be implemented just with software upgrade, or hardware upgrade for a conventional driving robot.

In addition, the aforementioned various embodiments of the disclosure may also be performed through an embedded server provided on a driving robot, or at least one external server.

According to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. Also, a storage medium that is readable by a machine may be provided in the form of a non-transitory storage medium. Here, the term ‘non-transitory’ only means that the storage medium does not include a signal and is tangible, and does not distinguish whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed on-line in the form of a storage medium that is readable by machines (e.g.: compact disc read only memory (CD-ROM)), or through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned various embodiments (e.g.: a module or a program) may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. Also, operations performed by a module, a program, or other components according to the various embodiments may be executed sequentially, in parallel, repetitively, or heuristically. Or, at least some of the operations may be executed in a different order or omitted, or other operations may be added.

While example embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. A driving robot comprising:
a main body;
a plurality of driving modules that are rotatably connected on a lower side of the main body, each driving module of the plurality of driving modules comprising a sensor, a plurality of wheels, and a motor configured to drive the plurality of wheels; and
at least one processor configured to:
rotate each of the plurality of driving modules based on rotation directions of the plurality of driving modules that are determined based on a direction in which the robot is to drive,
identify at least one driving module, among the plurality of driving modules, that is not in contact with a bottom surface based on a sensing value of the sensor of the at least one driving module, and
control the motor of the at least one driving module to drive the plurality of wheels of the at least one driving module at different rotation speeds.

2. The driving robot of claim 1, wherein the at least one processor is further configured to:
based on the at least one driving module rotating in a rotation direction that is determined based on the direction in which the robot is to drive, control the motor of the at least one driving module to rotate the plurality of wheels of the at least one driving module at a same rotation speed.

3. The driving robot of claim 1, wherein the at least one processor is further configured to:
based on identifying that the at least one driving module is not in contact with the bottom surface, control the motor of the at least one driving module to rotate a wheel, among the plurality of wheels of the at least one driving module, disposed on an opposite side of the rotation direction that is determined for the at least one driving module at a speed that is faster than rotation speeds of the plurality of wheels of each of remaining driving modules of the plurality of driving modules, and
rotate a wheel arranged in the rotation direction, among the plurality of wheels of the at least one driving module, at a speed slower than rotation speeds of the wheels of the plurality of wheels of each of remaining driving modules of the plurality of driving modules.

4. The driving robot of claim 1, further comprising:
memory,
wherein the at least one processor is further configured to:
obtain first odometry information of the robot based on sensing values of the sensor of each of the plurality of driving modules while the robot is driving according to driving of the plurality of driving modules and store the information in the memory,
based on the at least one driving module, among the plurality of driving modules, not contacting the bottom surface, obtain second odometry information of the robot based on sensing values of the sensor of each of remaining driving modules of the plurality of driving modules excluding the at least one driving module and store the information in the memory, and
identify a location of the robot based on the first odometry information and the second odometry information.

5. The driving robot of claim 1, wherein the at least one processor is further configured to:
based on identifying that a load current of the motor of at least one driving module among the plurality of driving modules became smaller than load currents of the motors of remaining driving modules, among the plurality of driving modules, by greater than or equal to a predetermined amount, identify the at least one driving module including the motor having the identified load current as the driving module that is not in contact with the bottom surface.

6. The driving robot of claim 1, wherein the sensor comprises an absolute encoder configured to sense a rotation direction of the driving module, and
wherein the at least one processor is further configured to:
based on identifying a driving module, among the plurality of driving modules, that did not rotate in a rotation direction determined based on the direction in which the robot is to drive, identify the driving module as the driving module that is not in contact with the bottom surface based on an output value of the absolute encoder.

7. The driving robot of claim 1, wherein the at least one processor is further configured to:
based on identifying that a driving route of the robot is a straight route, control the motor of the at least one driving module to rotate the plurality of wheels of the at least one driving module at different rotation speeds until the at least one driving module is aligned with remaining driving modules of the plurality of driving modules, and
based on identifying that the at least one driving module was aligned with the remaining driving modules based on a sensing value of the sensor, control the motor provided in the at least one driving module to rotate the plurality of wheels of the at least one driving module at a same speed as the plurality of wheels of each of the remaining driving modules.

8. The driving robot of claim 1, wherein the at least one processor is further configured to:
based on identifying that a driving route of the robot is a curved route, control the motor of the at least one driving module to rotate the plurality of wheels of the at least one driving module at different rotation speeds until the at least one driving module rotates in the determined rotation direction, and
based on identifying that the at least one driving module was aligned in the determined rotation direction based on a sensing value of the sensor of the at least one driving module, control the motor of the at least one driving module to adjust the rotation speeds of the plurality of wheels of the at least one driving module to a same target speed, and
wherein the determined rotation direction is determined based on a relation between a location of a center of rotation of the curved route and a location of the at least one driving module.

9. A driving method of a driving robot comprising a plurality of driving modules, the driving method comprising:
rotating each of the plurality of driving modules such that the plurality of driving modules rotate in rotation directions of each of the plurality of driving modules that are determined based on a direction in which the driving robot is to drive;
identifying at least one driving module, among the plurality of driving modules, that is not in contact with a bottom surface; and
rotating a plurality of wheels included in the at least one driving module at different rotation speeds.

10. The driving method of a driving robot of claim 9, further comprising:
based on the at least one driving module rotating in a rotation direction that is determined based on the direction in which the robot is to drive, rotating the plurality of wheels of the at least one driving module at a same rotation speed.

11. The driving method of a driving robot of claim 9, wherein the rotating the plurality of wheels of the at least one driving module at different rotation speeds comprises:
rotating a wheel, among the plurality of wheels of the at least one driving module, disposed on an opposite side of the rotation direction that is determined for the at least one driving module at a speed faster than the rotation speeds of the wheels provided in remaining driving modules of the plurality of driving modules; and
rotating a wheel arranged in the rotation direction among the plurality of wheels of the at least one driving module at a speed slower than rotation speeds of wheels of the remaining driving modules of the plurality of driving modules.

12. The driving method of a driving robot of claim 9, further comprising:
obtaining first odometry information of the robot while the robot is driving according to driving of the plurality of driving modules;
based on the at least one driving module among the plurality of driving modules not contacting the bottom surface, obtaining second odometry information of the robot based on information obtained from the remaining driving modules excluding the at least one driving module; and
identifying a location of the robot based on the first odometry information and the second odometry information.

13. The driving method of a driving robot of claim 9, wherein the identifying the at least one driving module that is not in contact with the bottom surface comprises:
based on identifying that a load current of a motor included in at least one driving module among the plurality of driving modules became smaller than load currents of motors included in remaining driving modules among the plurality of driving modules by greater than or equal to a predetermined amount, identifying the at least one driving module including the motor having the identified load current as the at least one driving module that is not in contact with the bottom surface.

14. The driving method of a driving robot of claim 9, wherein the identifying the at least one driving module that is not in contact with the bottom surface comprises:
based on identifying a driving module, among the plurality of driving modules, that did not rotate in a rotation direction determined based on the direction in which the robot is to drive, identifying the identified driving module as the driving module that is not in contact with the bottom surface based on an output value of an absolute encoder included in each of the plurality of driving modules.

15. The driving method of a driving robot of claim 9, further comprising:
based on identifying that a driving route of the robot is a straight route, controlling the motor of the at least one driving module to rotate the plurality of wheels of the at least one driving module at different rotation speeds until the at least one driving module is aligned with remaining driving modules of the plurality of driving modules; and
based on identifying that the at least one driving module was aligned with the remaining driving modules based on a sensing value of the sensor, controlling the motor provided in the at least one driving module to rotate the plurality of wheels of the at least one driving module at a same speed as the plurality of wheels of each of the remaining driving modules.

16. The driving method of a driving robot of claim 9, further comprising:
based on identifying that a driving route of the robot is a curved route, controlling the motor of the at least one driving module to rotate the plurality of wheels of the at least one driving module at different rotation speeds until the at least one driving module rotates in the determined rotation direction, and
based on identifying that the at least one driving module was aligned in the determined rotation direction based on a sensing value of the sensor of the at least one driving module, controlling the motor of the at least one driving module to adjust the rotation speeds of the plurality of wheels of the at least one driving module to a same target speed, wherein the determined rotation direction is determined based on a relation between a location of a center of rotation of the curved route and a location of the at least one driving module.

17. A non-transitory computer-readable recording medium storing computer instructions which, when executed by a processor of a driving robot including a plurality of driving modules, cause the driving robot to perform operations comprising:
rotating each of the plurality of driving modules such that the plurality of driving modules rotate in rotation directions of each of the plurality of driving modules that are determined based on a direction in which the driving robot is to drive;
identifying at least one driving module, among the plurality of driving modules, that is not in contact with a bottom surface; and
rotating a plurality of wheels included in the at least one driving module at different rotation speeds.

18. The non-transitory computer-readable recording medium of claim 17, further comprising:
based on the at least one driving module rotating in a rotation direction that is determined based on the direction in which the robot is to drive, rotating the plurality of wheels of the at least one driving module at a same rotation speed.

19. The non-transitory computer-readable recording medium of claim 17, further comprising:
based on identifying that the at least one driving module is not in contact with the bottom surface, rotating a wheel, among the plurality of wheels of the at least one driving module, disposed on an opposite side of the rotation direction that is determined for the at least one driving module at a speed that is faster than rotation speeds of the plurality of wheels of each of remaining driving modules of the plurality of driving modules, and
rotating a wheel arranged in the rotation direction, among the plurality of wheels of the at least one driving module, at a speed slower than rotation speeds of the wheels of the plurality of wheels of each of remaining driving modules of the plurality of driving modules.

20. The non-transitory computer-readable recording medium of claim 17, further comprising:
obtaining first odometry information of the robot based on sensing values of the sensor of each of the plurality of driving modules while the robot is driving according to driving of the plurality of driving modules and storing the information in the memory,
based on the at least one driving module, among the plurality of driving modules, not contacting the bottom surface, obtaining second odometry information of the robot based on sensing values of the sensor of each of remaining driving modules of the plurality of driving modules excluding the at least one driving module and storing the information in the memory, and
identifying a location of the robot based on the first odometry information and the second odometry information.
